(19) United States
(12) Patent Application Publication
(10) Pub. No.: US 2024/0417299 A1
(43) Pub. Date: Dec. 19, 2024

(54) MOLECULAR MODIFICATION PROCESS FOR WASTEWATER TREATMENT AND PURIFICATION

(71) Applicant: Eduardo VALDÉS RANGEL, Ciudad de Mexico (MX)

(72) Inventor: Eduardo VALDÉS RANGEL, Ciudad de Mexico (MX)

(21) Appl. No.: 18/701,228

(22) PCT Filed: Oct. 4, 2022
(86) PCT No.: PCT/MX2022/050089

§ 371 Date: Apr. 13, 2024

(30) Foreign Application Priority Data
Oct. 15, 2021 (MX) MX/A/2021/012729

(51) Int. Cl. C02F 9/00; B01J 39/04; B01J 39/18; C02F 1/42; C02F 1/50; C02F 1/70; C02F 1/78; C02F 101/10; C02F 101/20; C02F 101/22; C02F 101/32

(52) U.S. Cl. CPC C02F 9/00; B01J 39/04; B01J 39/18; C02F 1/42; C02F 2001/425; C02F 1/50; C02F 1/70; C02F 1/78; C02F 2101/103; C02F 2101/105; C02F 2101/203; C02F 2101/206; C02F 2101/22; C02F 2101/32; C02F 2301/08; C02F 2303/04

(57) ABSTRACT

A water treatment and purification process for the removal of contaminants from water, which uses a resin polymeric resin based on allylbenzene (3-phenylpropene) with divinylbenzene, which has been previously activated, which carries out an ion exchange and adsorption of the contaminants present in the water to be treated. The molecular modification process for the treatment and purification of water allows purifying water with high concentrations of both organic and inorganic contaminants, does not clog or scale, removes the contaminants from the water, does not generate any type of rejection or waste, does not generate sludge, and operates with low energy consumption.

### CROSS-REFERENCE TO RELATED APPLICATIONS

This application is a US national stage under 35 USC 371 of PCT/MX2022/050089 filed on Oct. 10, 2022, which claims priority to Mexican application no. MX/a/2021/012729 filed on Oct. 15, 2021. The entire content of these applications is incorporated by reference herein.

### FIELD OF THE INVENTION

The present invention is related to water treatment and purification processes through the use of ion exchange resins, more specifically, a process of water treatment and purification by means of a sequence of treatment units with allylbenzene (3-phenylpropene) based resins with divinylbenzene.

### BACKGROUND OF THE INVENTION

Water is becoming increasingly scarce worldwide, and we must avoid wasting it, mainly due to the wastewater discharges carried out by various production industries and in the tourism sector, as well as residential use.

In wastewater, there are a series of pollutants, both inorganic and organic, the former can be dissociated, because they are of the ionic or polar type, as an example we can quote all salts formed by various metals with chlorides, phosphates, nitrates, sulphates, carbonates, etc.

The latter do not dissociate completely in water because they lack polarity or a defined ionic charge, such is the case with natural and synthesized dyes, vegetable pigments and synthesized pigments, soaps, fats, oils, aromas, essences, proteins, antibiotics, vitamins, detergents, etc. In whose molecular structures, one or more of the alkene, alkyne, arene, alcohol, ether, amine, aldehyde, ketone, carboxylic acids, ester, amide, and azo groups are found in their molecular structure. In addition, the size of their molecules is very large compared to that of salts or inorganic compounds.

Large quantities of wastewater are a global environmental problem that has been addressed through a myriad of purification procedures. Each procedure consists of several stages that depend mainly on the type of contaminants present in the water to be treated, as well as the quantities of the water to be treated, the quality of the water to be recovered and the resources available to carry out the procedure. Some of the most common procedures are filtration, microfiltration, ultrafiltration, precipitation, degradation, reverse osmosis, among others.

In order to remove very small particles (smaller than 5 microns), procedures such as ultrafiltration and reverse osmosis are commonly used. However, these procedures involve a very large waste of water since the waste that is rejected by the osmosis membrane or filter is gradually concentrated in the untreated water, which must be discarded when the concentration of contaminants in the water is too high to be treated.

Also, the membranes and filters used in these two processes tend to suffer from fouling and clogging due to the effect of both organic and inorganic contaminants that reduce their efficiency and, therefore, imply the addition of anti-fouling and anti-scaling chemicals to the water to be treated, leading to an increase in both water contamination and the costs of the treatment process.

To detect organic contaminants in wastewater, the National Standards that regulate the discharge of wastewater, such as NOM-001-ECOL-1996 and NOM-003-ECOL-1997, use the Biological Oxygen Demand (BOD5) as parameters and the metals are analyzed individually and mainly zinc, lead, nickel, chromium, copper and mercury.

As a solution to the aforementioned problems, wastewater treatment has been implemented using adsorption and ion exchange resins, which are designed to adsorb and retain contaminants. For the most part, adsorption and ion exchange resins are selective with respect to the contaminants they remove, which is why they are mainly used in treatment processes where a specific contaminant is sought to be removed from water.

Styrene is one of the main monomers used in the manufacture of ion exchange resins, and in order to achieve a larger surface area for greater adsorption and particle retention capacity, cross-linking compounds have been implemented that cross-link the polymeric styrene chains forming branches that on a larger scale translated into lattices or pores within the particles. One of the main cross-linking compounds used today for the manufacture of adsorption and ion exchange resins is divinylbenzene.

In many cases, the aim is not only to obtain purified water as a product of the treatment, but also to recover some of the contaminants that may have a high value. To achieve the recovery of a specific contaminant, resins have been manufactured that are highly selective, i.e., they focus on the retention of a specific compound or type of compound, such as petroleum, heavy metals, organic matter, dyes, etc. However; This type of resin does not allow a comprehensive wastewater treatment, i.e., to remove all types of contaminants (organic, inorganic, ions, etc.).

This is due to the fact that these resins can only adsorb a specific type of components and not the total of the contaminants contained in the water, and to date there is no known procedure to achieve a comprehensive removal of contaminants from water from water using only ion exchange resins, with which they can also be recovered separately at the end of the process.

It should be mentioned that the resins described above, i.e. those that have a selective adsorption of the components, usually go through a reactivation stage after the water treatment through which the adsorbed contaminants are recovered.

Some patents describing this reactivation treatment in organic compound adsorption resins are: BE674884, CN1810664, CA2158404 and DE4215741. This type of procedure is also described for adsorption resins of inorganic compounds as shown in patents GB900807, CN102942239, and CN101804333.

There are some ion exchange resins that do not have a high selectivity, i.e. they can adsorb various types of compounds, achieving better water cleanliness. Application WO200027896 describes a resin containing divinylbenzene that can adsorb contaminants such as dyes, organic compounds, surfactants and heavy metals alike.

Similarly, patents CN102827393 and RU2085503 describe resins that adsorb petroleum derivatives together with some metal ions or heavy metals. When these types of resins are used to treat contaminated water, a higher purity of the water since adsorption of a wide variety of contaminants is achieved. However, this type of treatment still does not achieve the required water purity results or can become excessively expensive.

In order to achieve higher water purity, staged resin water treatment processes have also been described. Patent DE4204573 mentions a process for purification of contaminated water in which the liquid is passed through various tanks with styrene-based polymer resins, however, selective adsorption of contaminants is not achieved in this process.

Also, patent GB1401784 describes a process that uses various stages with polymer resins to treat wastewater. However; this process is highly selective for adsorbing dyes and therefore cannot be implemented to achieve comprehensive water cleaning of wastewater with various contaminants.

GB2166140B, describes an absorbent, for use in the removal of heavy metal cations from water and the removal of organic coloring matter from sugar cane juice and antibiotic solutions (e.g. neomycin and gentamicin) has a microporous structure, a surface area of 35-45 m2/g, a physical strength tested in the Chatteliar tester of 800-900 g, and a bulk density of 750-760 g/L. It is prepared by subjecting cross-linked styrene/vinylbenzene copolymer beads to in situ chloromethylation in the presence of chloromethylmethyl ether followed by subjecting the chloromethylated copolymer thus obtained to amination with a secondary amine with or without a monoamine.

Paper CN104119466A describes a high-capacity anion exchange resin with a bifunctional group and a method of synthesis of the same and belongs to the field of synthesis and application of environmental functional materials. Chloromethylated polystyrene-diyinylbenzene polymer is taken as the primary material and then undergoes a primary amination reaction and a quaternary amination reaction to obtain the anion exchange resin with a bifunctional group that has the functions of anionic group of weak alkali and strong alkali type. Anion exchange resin has a high absorption capacity of nitrate ions in water, can effectively absorb natural organic acids such as phytic acid in water, is able to remove nitrate ions in water and phytic acid organisms, and therefore has a wide application prospect in fields of drinking water treatment, groundwater repair, and deep treatment of city domestic sewage.

CN101249423B, describes a unit of structure of a pyranyl-modified adsorbent resin with composite function is shown in the FIGURE with a specific surface area of 50-1600 m\hat{ }{2}/g, a micropore volume of 0.01 to 1.0 cm\hat{ }{3}/g, and an exchange capacity of 0.1 A 5.0 mmol/g. The resin is prepared by swelling chlorine beads in a solvent such as nitrobenzene; adding catalyst to obtain polystyrene-divinylbenzene adsorbent resin; removing the reaction stock solution; washing to remove residual solvent and catalyst; swelling; adding pyran reagent to further react with the residual chloromethyl on the inner and outer surfaces of the resin to obtain the pyranyl-modified adsorbent resin with the composite function. The resin has dual effects including absorption and ion exchange (coordination); and simultaneously has hydrophilic basic pyranyl functional groups and hydrophobic styrene frameworks and has good affinity for amphoteric bioreagents such as protein. The pyranil functional group has a similar compatibility to that of the natural flavonoid pigment, and especially facilitates the extraction of the natural pigment.

CN103127745A, describes a purification method for decarburizing alcohol amine in a CO2 recovery apparatus, and pertains to the field of application of a process for purifying an alcohol amine solution using an anion exchange resin. The decarburization alcohol amine solution is added to a desalination resin tank (HSSX) from the top of the demineralization resin tank and desalinated by exchanging it with the resin; and a purified decarburization alcohol amine solution is obtained after discharging the decarburization alcohol amine from the HSSX tank. The anion exchange resin is used to remove the thermostable salts from the alcohol amine solution, so that an object is made to purify the amine alcohol solution. In addition, the anion exchange resin can be regenerated using a small amount of a low-concentration sodium hydroxide solution and the lifetime of the resin is long, thus reducing the cost consumption of M an amine solution purification system.

CN101314124B describes a polymeric adsorbent of high hydrophobicity that is polymerized and cross-linked with (1) styrene, (2) p-methylstyrene, 4-tert-butylstyrene, 4-isobutylstyrene or a mixture of p-methylstyrene, 4-tert-butylstyrene and 4-isobutyl styrene according to an arbitrary ratio and (3) divinylbenzene. The compositions per portion by weight of the polymeric adsorbent are: 30 to 70 portions of (1) styrene, 20 to 60 portions of (2) p-methylstyrene, 4-tert-butylstyrene, 4-isobutylstyrene or the mixture of p-methylstyrene, 4-tert-butylstyrene and 4-isobutylstyrene according to the arbitrary ratio, and from 2.5 to 10 portions of (3) divinylbenzene; the specific surface area of the polymeric adsorbent is greater than or equal to 820 m2/g; the pore volume of the polymeric adsorbent is greater than or equal to 0.5 cm3/g; the microporosity of the polymeric adsorbent is greater than or equal to 50 percent; the pore diameter of the polymeric adsorbent is concentrated between 1.5 and 2.2 nm; and an envelope angle between the polymeric adsorbent and water is between 13° and 149° C. The microporous polymeric adsorbent with high hydrophobicity can be applied to the treatment and recycling of organic waste gases. The invention describes a method for preparing the microporous polymeric adsorbent of high hydrophobicity.

CN104892818A, describes a method of preparing an anion exchange resin, sequentially comprising the following steps: aqueous phase: adding pure water, a dispersing agent and methylene blue in a polymerization kettle, stirring and heating to 50° C. for subsequent use; and oily phase: adding styrene, divinylbenzene and an initiator in a mixing kettle at room temperature, mixing uniformly, adding the oily phase in the in aqueous phase polymerization kettle, carrying out staggered heating while stirring, keeping the polymerization in suspension until the temperature is 96-103° C., initiating curing to obtain a reactant white ball of polymer beads, stirring the stock solution, washing the polymer white ball in a filter with pure hot water at 90° C. more than three times, performing vacuum drying on the clean white ball in fluidized bed and screening to obtain the finished product.

US2015266015A1 describes a method for removing a perchlorate ion (ClO4−) and a nitrate ion (NO3−) which are toxic anions in wastewater using an anion exchange resin on which a metal is rested, and more particularly an anion exchange resin on which a hydrogen is supported. An activating metal or a hydrogen activating metal and a secondary metal are supported together and a method is used to remove toxic anions using the same. Toxic anions can be ion-exchanged and removed efficiently using an anion exchange resin supporting a reduction catalyst, regeneration of the anion exchange resin can be facilitated, and energy consumption and reducing agent can be reduced, so that they can be used in the removal of toxic anions from an actual water purification system.

MX/a/2016/005609, describes a water treatment process and system for the removal of contaminants from water, which uses a styrene-based polymer resin containing divinylbenzene, which has been previously activated, to carry out an ion exchange and adsorption of the contaminants present in the water to be treated. The amount in weight of divinylbenzene in relation to the styrene in the resin will determine the size and the amount of pores present in the resin; that is, the greater the amount of divinylbenzene present in the resin, the more reticulated its structure, resulting in greater porosity, which will allow the selective adsorption of the contaminants by the resin. Where the water is pre-treated before undergoing the ion exchange and contaminant adsorption stage, by inducing oxidation-reduction reactions by means of ozone.

PA/a/1997/002492, describes a process for the removal of dissolved organic carbon from water. The process includes the following steps, adding an ion exchange resin to the water containing a contaminant such as dissolved organic carbon, dispersing the resin into the contaminated water to allow adsorption of the dissolved organic carbon onto the resin, and separating the resin loaded with the contaminant from the water. In a preferred embodiment, the process employs a magnetic ion exchange resin. Where the resin used in the process has divinylbenzene, a compound that cross-links the beads and provides greater porosity, generating better adsorption.

US2020189938 A1, describes a method for producing purified water comprising a stage of passing water through an ultrafiltration medium and a mixed bed ion exchanger, comprising macroporous beads providing a large surface area and having a pore size from 20 to 100 nm and a diameter of 0.2 to 0.7 mm, preferably 0.5 to 0.7 mm. Wherein further, the ion exchange resin is a cross-linked polymer of styrene and divinylbenzene.

WO9809916 A1, describes a process for obtaining ultrapure water, wherein the water is first subjected to an advanced oxidation process before undergoing ion exchange and adsorption of contaminants, and wherein the advanced oxidation process consists of exposing the water to ultraviolet light.

WO2014045109 A1, describes a treatment method for petroleum refinery effluent, wherein the effluent first undergoes an advanced oxidation process and then passes through an ion exchange and contaminant adsorption stage; where the advanced oxidation process consists of adding an oxidizing agent (sodium hypochlorite, calcium hypochlorite, hydrogen peroxide, potassium permanganate, chlorine dioxide, chlorine gas, ozone and its derivatives) to the effluent to be treated.

In view of the above, in the state of the art we find that there are methods, devices, systems, ion exchange resins, for the treatment and purification of wastewater, but current technologies are not capable of removing both organic and inorganic contaminants together, without generating sludge or rejecting water.

To overcome this problem, several companies and researchers worldwide have used ion exchange resins, manufactured by copolymerizing styrene with divinylbenzene and exchange groups such as sulfate or amines, with several variants, both in the monomers and in the type of exchange groups that have given these resins a certain adsorption capacity, this adsorption is mainly based on the increase of the cross-linking level, formed by the addition of different proportions of divinylbenzene, which gives rise to the formation of internal pores in the resin, leading to the following problems:
1. The more cross-linking, the smaller the pores of the resin and the more difficult the ionic diffusion.
2.—Resins with a low degree of cross-linking have larger pores and the diffusion of ions is facilitated, but if the cross-linking is very little, the hydration becomes excessive, causing the resin to be very soft, making it difficult to handle.
3.—When the resin is hydrated by the hydration effect of fixed ions (HSO4−; =N=+) and exchange ions (H+; HO−), the resin swells due to osmotic pressure. A resin with excessive crosslinking loses elasticity.
4.—Resins with a high degree of crosslinking and therefore a high number of pores are called macroporous, but they have less exchange capacity than regular resins.
5.—Fully adsorbent resins do not have functional groups and therefore can only adsorb non-polar organic compounds.
6.—Oxidizing agents adhere to the polymer chain and oxidize it, leading to irreversible swelling.
7.—The lower the degree of cross-linking, the easier it is for swelling to occur due to oxidation.

In view of the foregoing, the state of the art describes methods, devices, systems and ion exchange resins for the treatment and purification of wastewater, but there is a need to improve the problems described.

### SUMMARY OF THE INVENTION

An embodiment of the present invention solves these problems by having a selective purification procedure based on the use of resins based on allylbenzene (3-phenylpropene) with divinylbenzene, which allows to purify water in an integral way, freeing it from all types of contaminants, obtaining high purity water as a final product without incurring excessive costs.

An embodiment of the present invention achieves a water treatment process, whereby water can be freed from a large number of contaminants in a selective manner to achieve high degrees of purity at a low cost.

The process of an embodiment of the present invention has the following advantages:
1.—It can purify water with high concentrations of both organic and inorganic contaminants, with more than 40,000 milligrams per liter of each of them.
2.—It does not clog or scale.
3.—It removes contaminants from the water, without generating any type of rejection or waste, nor does it generate sludge.
4.—Low energy consumption to operate.
5.—Depending on the concentration of the contaminants present, it can produce its own chemical reagents for its operation.

An aspect of an embodiment of the present invention is to provide a molecular modification process for water treatment which basically comprises inducing the adsorption phenomenon, this induction first consists in preparing the medium in which the adsorption will take place, commonly ion exchange resins are used as medium, these resins have previously had their crosslinking percentage modified, with the purpose of increasing their internal contact area and increasing their degree of elasticity, so that they can house high molecular weight molecules and these can be adsorbed inside the resin, the inner part of the resin is covered with a film formed by a chemical compound similar to the ligand of the resin itself.

After preparing the medium where the adsorption will be carried out, the next step is to prepare the contaminant molecule, this preparation consists of polarizing the non-polar molecules or dissociating those of low solubility, this polarization can be carried out using strong oxidizing agents such as ozone, chlorine, or hydroxyl groups, but if the molecule cannot be polarized by oxidation, reduction processes are used in strongly acidic media. Once the molecules have been polarized, they are introduced into the modified resin, where the so-called Van der Waals forces between the polarized molecules and the ionized surface of resin are elicited. By inducing adsorption in this way, not only organic but also, inorganic compounds are retained, which results in the high-quality water at the endo of the Molecular Modification process in terms of its electrolytic conductivity values, as well as very low values of: Biochemical Oxygen Demand (BOD), and Chemical Oxygen Demand (COD), Fats and Oils, Nitrates, Chlorides, Phosphates, among others.

A main objective of an embodiment of the present invention is to achieve a degree of cross-linking, which must be sufficient to generate micropores in which organic contaminants are adsorbed, at the same time, possessing exchange groups, with which they can adsorb inorganic contaminants, without affecting the elasticity and at the same time present resistance to oxidizing agents such as ozone or chlorine. This was achieved by copolymerization of allylbenzene (3-phenylpropene) with divinylbenzene. This copolymerization gave rise to the formation of adsorption units, which due to their properties have been called synthetic granulated minerals, with the following specifications: A polymeric exchange resin based on allylbenzene with a 20% content of divinylbenzene, which has a cross-linking percentage of 16% and an increase of the internal contact area by 53%; as well as the elasticity is increased from 40% to 55% in relation to a macroporous resin, with 8% cross-linking percentage.

Using this type of granulated synthetic minerals, a process known as molecular modification has been developed, used in the purification of industrial, tourist and domestic wastewater.

### BRIEF DESCRIPTION OF THE DRAWINGS

FIG. 1 shows the process diagram of this invention.

### DETAILED DESCRIPTION OF THE INVENTION

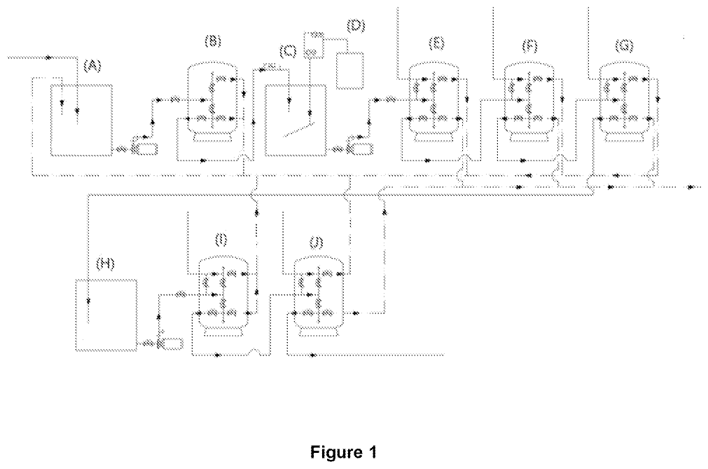

With reference to FIG. 1, the molecular modification process for wastewater treatment and purification consists of seven basic stages, which are described below:

### First Stage

### Liquid/Solid Phase Oxidation.

The water in (B), see FIG. 1, is passed through a bed made of a material composed of manganese and iron, which has a high molecular weight and a high degree of oxidation; this initiates the oxidation process of both organic and inorganic molecules, while filtering suspended solids larger than 50 microns and due to their bacteriostatic properties, it does not allow microbial proliferation, achieving at this stage a removal of 2 to 10% of both organic and inorganic contaminants present in the water.

### Second Stage

### Liquid/Gas Phase Oxidation.

Then, in (C), ozone gas is added directly to the water, at concentration levels of 6 to 8 ppm, by means of an ozonator (D), which seeks to continue with the oxidation processes, both for organic and inorganic molecules, as well as for the breakage of the cell wall of infectious pathogens. In this stage, normally the destruction or total breakage is not achieved by the ozonolysis performed on the pi and sigma bonds, however the effect produced by the ozone gas in excess in the water, is first to oxidize the metals that due to their oxidation state are soluble, as an example, Fe²⁺ is oxidized to Fe³⁺ and secondly, dipole moments are generated in the organic molecules of medium to low molecular weight, which is used in the following stages.

### Third Stage

### Reduction/Adsorption of Metals and Fats

Subsequently, the water passes through a bed of polymeric ion exchange resin in (E), where the resin is modified with sulfonic acid or dibasic sodium phosphate for the adsorption of organic compounds, such as fats and oils, aided by Van der Waals forces; at the same time, the metals iron, manganese, calcium, magnesium and chromium V are exchanged for protons, which develop reduction reactions in the bonds of the organic molecules and protonate the other salts that were neither exchanged or adsorbed in the following stages. In this stage, a 15 to 20% removal of both organic and environmental contaminants present in the water is achieved.

### Fourth Stage

### Oxidation/Adsorption of Organic and Inorganic Molecules.

Then, the water passes through a bed of polymeric ion exchange resin in (F), where the resin is modified with a secondary amine, methyl-propyl-amine, and with a tertiary amine, trimethylamine, in hydroxyl cycle for the adsorption of organic compounds, such as: aldehyde, ketone, carboxylic, ester and azo groups, which, depending on their molecular structure, their bonds can be broken to form smaller units by the effect of the oxidation of the hydroxyl groups, likewise the salts formed with sulfates, nitrates, chlorides groups, of high dissociation are exchanged for hydroxyl groups. At this stage, a 15 to 20% removal of both organic and inorganic contaminants present in water is achieved.

### Fifth Stage

### Oxidation/Adsorption of Organic and Inorganic Molecules.

It then passes through a bed of ion exchange polymeric resin in (G), where the resin is modified with a tertiary amine, trimethylamine, for the adsorption of organic compounds containing alkene, alkyne and arene groups, which, depending on their molecular structure, their bonds can be broken, by the oxidation of hydroxyl groups to form smaller units, likewise salts with carbonate and phosphate groups are exchanged for hydroxyl groups. At this stage, a removal of 15 to 20% of both organic and inorganic contaminants present in the water is achieved.

### Sixth Stage

### Adsorption/Reduction of Organic and Inorganic Molecules.

Subsequently, the water passes through a bed of ion exchange polymeric resin in (I), where the resin is modified with sulfonic acid, for the adsorption of organic compounds, due to the effect of reduction reactions in the bonds of the alkenes, alkynes and amide groups, simultaneously exchanges of metal ions, sodium, chromium III, zinc, cadmium, nickel and lead are carried out. At this stage, a removal of 15 to 20% of both organic and inorganic contaminants present in the water is achieved.

### Seventh Stage

### Adsorption/Oxidation of Organic and Inorganic Molecules.

Finally, the water passes through a bed of polymeric ion exchange resin in (J), where the resin is modified with a secondary amine, methyl-propyl-amine, and a tertiary amine, trimethylamine, for the adsorption of low molecular weight organic compounds, resulting from the previous stages, simultaneously adsorbing arsenic, cyanides, silica and phosphates. At this stage, a removal of 15 to 20% of both organic and inorganic contaminants present in the water is achieved.

### Reactivation:

Once the granulated synthetic minerals are saturated with organic and inorganic compounds, they are reactivated by the introduction of acidic and alkaline solutions either in pure form or combined with sodium or potassium salts, so that they can be used again for the purification of more wastewater.

It should be noted that an embodiment of this invention, unlike those published, presents as an innovation the simultaneous adsorption and ion exchange of organic and inorganic compounds, respectively, having water as a medium and that the process is composed of several stages complementary to each other, in which some prepare the molecules so that in others, the adsorption and ion exchange processes are carried out, it is also important to note that thanks to the structure conferred by the allylbenzene monomer, the granulated synthetic minerals can resist high concentrations of oxidizing agents, due to the high percentage of cross-linking achieved by the size of their molecule.

In particular, an embodiment of the present invention refers to a molecular modification process for the treatment and purification of wastewater, comprising the following stages:
a) Filtering suspended solids larger than 50 microns in water;
b) Passing the water through a bed composed of manganese and iron, which has a high molecular weight and a high degree of oxidation, allowing the oxidation in liquid-solid phase of the organic and inorganic molecules present in water;
c) Adding ozone gas to the water, at concentration levels of 6 to 8 ppm, which allows liquid-gas phase oxidation of the organic and inorganic molecules present in the water; as well as for the breakage of the cell wall of infectious pathogens;
d) Passing the water through a bed of polymeric ion exchange resin modified with an acid, where the acid is selected from: sulfonic acid or dibasic sodium phosphate, which allows a reduction-adsorption of metals and fats present in the water;
e) Passing the water through a bed of polymeric ion exchange resin modified with a base, where the base is a secondary amine, methyl-propyl-amine and a tertiary amine, trimethylamine, which allows an oxidation-adsorption of organic and inorganic molecules;
f) Passing the water through a bed of polymeric ion exchange resin modified with a base, where the base is a tertiary amine, trimethylamine, which allows an oxidation-adsorption of organic and inorganic molecules;
g) Passing the water through a bed of polymeric ion exchange resin modified with an acid, where the acid is sulfonic acid, which allows an adsorption-reduction of organic and inorganic molecules;
h) Passing the water through a bed of polymeric ion exchange resin modified with a base, where the base is a secondary amine, methyl-propyl-amine and a tertiary amine, trimethylamine, which allows adsorption-oxidation of organic and inorganic molecules.

### Example 1

Table 1 is shown below, where a series of parameters measured on industrial wastewater and the values obtained after that water was treated by the process of an embodiment of the present invention are observed.

TABLE 1

| | Pre- | Post- | |
|---|---|---|---|
| | treatment | treatment | |
| Parameter | value | value | Units |
| Helminth Eggs | <0.2 | <0.2 | H/L |
| Fecal Coliforms | <3 | <3 | NMP/100 mL |
| Fats & Oils | 807.14 | <10 | mg/L |
| Sediment Solids | 0.1 | <0.1 | mg/L |
| Total Suspended Solids | 645 | <10 | mg/L |
| BOD5 | 2250 | <10 | mg/L |
| Kjeldahl Total Nitrogen | 67.9 | <2 | mg/L |
| Nitrogen Nitrites | <0.02 | <0.02 | mg/L |
| Nitrogen Nitrates | <1.01 | <0.1 | mg/L |
| Total Nitrogen | 68.91 | <2 | mg/L |
| Total Phosphorus | 76.18 | <0.30 | mg/L |
| COD | 2976.95 | <10 | mg/L |
| Arsenic | 0.0045 | <0.003 | mg/L |
| Total Cadmium | 0.085 | <0.001 | mg/L |
| Total Cyanide | <0.2 | <0.2 | mg/L |
| Total Copper | 3.27 | <0.3 | mg/L |
| Total Chromium | 1.17 | <0.2 | mg/L |
| Total Mercury | 0.0027 | <0.002 | mg/L |
| Total Nickel | 11.21 | <0.2 | mg/L |
| Total Lead | 0.021 | <0.01 | mg/L |
| Zinc Total | 8.55 | <0.1 | mg/L |
| pH Average | 8.7 | 8.43 | |

### Example 2

Table 2 below shows a series of parameters measured in a wastewater from a municipal slaughterhouse and the values obtained after that water was treated by the process of an embodiment of the present invention.

TABLE 2

| | Pre-treatment | Post-treatment | |
|---|---|---|---|
| Parameter | value | Value | Units |
| BOD5 | 760 | <10 | mg/L |
| Fecal Coliforms | 17,000,000 | Not detectable | NMP/100 mL |
| Fats & Oils | 42.75 | <4.77 | mg/L |

From the results obtained, it can be very clearly observed that the wastewater treatment system in accordance with the principles of an embodiment of the present invention is effective in removing the contaminants present in the water in a highly effective way, since it can be verified that water of very high purity is obtained.

In view of what has been set forth in this detailed description of an embodiment of the invention, it is reiterated that the scope of the present invention should not be limited by the modalities particularly described, so that it will be understood that variations in various respects may be made. Such variations should not be considered as a deviation from the spirit and scope of the invention, and all such modifications may be employed by a person skilled in the art and should be included in the scope of the following claims.

I claim:

1-4. (canceled)

5. A molecular modification process for wastewater treatment and purification comprising:
filtering out suspended solids larger than 50 microns present in the water;
passing the water through a first bed composed of manganese and iron, having a high molecular weight and a high degree of oxidation, which allows the oxidation in the liquid-solid phase of organic and inorganic molecules;
adding ozone gas to the water, at concentration levels of 6 to 8 ppm, which allows liquid-gas oxidation of organic and inorganic molecules and for breaking down the cell wall of infectious pathogens;
passing the water through a second bed of polymeric ion exchange resin modified with a first acid, which allows a reduction-adsorption of metals and fats;
passing the water through a third bed of polymeric ion exchange resin modified with a first base, wherein the first base is comprised of a first secondary amine and a first tertiary amine, which allows an oxidation-adsorption of organic and inorganic molecules;
passing the water through a fourth bed of polymeric ion exchange resin modified with a second base, wherein the second base is a second tertiary amine, which allows an oxidation-adsorption of organic and inorganic molecules;
passing the water through a fifth bed of polymeric ion exchange resin modified with a second acid, which allows an adsorption-reduction of organic and inorganic molecules;
passing the water through a sixth bed of polymeric ion exchange resin modified with a third base, where the third base is comprised of a second secondary amine and a third tertiary amine, which allows the adsorption-oxidation of organic and inorganic molecules.

6. The molecular modification process for the wastewater treatment and purification according to claim 1, wherein the polymeric ion exchange resin of the second bed, the third bed, the fourth bed, the fifth bed, and the sixth bed is allylbenzene-based with 20% divinylbenzene content.

7. The molecular modification process for wastewater treatment and purification according to claim 1, wherein the first acid is selected from sulfonic acid and sodium dibasic phosphate, and the second acid is sulfonic acid.

8. The molecular modification process for wastewater treatment and purification according to claim 1, wherein the first secondary amine and the second secondary amine are methyl-propyl-amine, the first tertiary amine and the third tertiary amine are trimethylamine, and the second tertiary amine is trimethylamine.

9. A molecular modification process for wastewater treatment comprising:
filtering out suspended solids larger than 50 microns present in the water to be treated;
passing the water to be treated through a first bed composed of manganese and iron, having a high molecular weight and a high degree of oxidation;
adding ozone gas to the water to be treated, at concentration levels of 6 to 8 ppm;
passing the water to be treated through a second bed of polymeric ion exchange resin modified with a first acid;
passing the water through a third bed of polymeric ion exchange resin modified with a first base, wherein the first base is comprised of a first secondary amine and a first tertiary amine;
passing the water through a fourth bed of polymeric ion exchange resin modified with a second base, wherein the second base is a second tertiary amine;
passing the water through a fifth bed of polymeric ion exchange resin modified with a second acid;
passing the water through a sixth bed of polymeric ion exchange resin modified with a third base, where the third base is comprised of a second secondary amine and a third tertiary amine.

10. The process of claim 1, wherein the polymeric ion exchange resin of the second bed is allylbenzene-based with 20% divinylbenzene content.

11. The process of claim 1, wherein the first acid is selected from sulfonic acid and sodium dibasic phosphate.

12. The process of claim 1, wherein the second acid is sulfonic acid.

13. The process of claim 1, wherein the second tertiary amine is trimethylamine.

14. The process of claim 1, wherein the first secondary amine is methyl-propyl-amine, and the first tertiary amine is trimethylamine.

15. The process of claim 1, wherein the second secondary amine is methyl-propyl-amine, and the third tertiary amine is trimethylamine.

16. The process of claim 10, wherein the polymeric ion exchange resin has a cross-linking percentage of 16% and an increase of an internal contact area by 53% in relation to a macroporous resin;

17. The process of claim 10, wherein the polymeric ion exchange resin has an increase in elasticity from 40% to 55% in relation to a macroporous resin, with 8% cross-linking percentage.
